(19) United States
(12) Patent Application Publication
(10) Pub. No.: US 2026/0275962 A1
(43) Pub. Date: Sep. 17, 2026

(54) WIND TURBINE, WIND POWER PLANT AND METHOD FOR CONTROLLING A WIND TURBINE AND A WIND POWER PLANT

(71) Applicant: Wobben Properties GmbH, Aurich (DE)

(72) Inventors: Ralf MESSING, Aurich (DE); Dennis DIETZ, Bremen (DE); Paul HAVLICEK, Münster (DE)

(21) Appl. No.: 19/672,277

(22) Filed: May 8, 2026

Related U.S. Application Data
(63) Continuation of application No. 17/840,398, filed on Jun. 14, 2022, now abandoned.
Application No. 17/840,398 is a division of application No. 17/046,266, filed on Apr. 15, 2019, now abandoned.

(30) Foreign Application Priority Data
Apr. 13, 2018 (DE) 10 2018 108 858.2

(51) Int. Cl. F03D 7/04

(52) U.S. Cl. CPC F03D 7/048; F05D 2260/70; F05D 2270/80

(57) ABSTRACT

A wind turbine having a wake control system that is configured so as to control the wind turbine on the basis of wake effects caused at a further wind turbine, wherein the wake control system is configured so as to achieve control based on a turbulence measured value from a turbulence measurement sensor of the further wind turbine. A wind turbine having a turbulence measurement sensor that is configured so as to determine a turbulence measured value, wherein the turbulence measured value is indicative of a turbulence and/or wind shear at the wind turbine, wherein the wind turbine is configured so as to provide the turbulence measured value in order to control the wind turbine and/or a further wind turbine. A wake control system for a wind turbine, but also an improved wind farm and an improved method for controlling a wind turbine and a wind farm.

### BACKGROUND

### Technical Field

The present invention relates to a wind turbine, to a wind farm and to a method for controlling a wind turbine and a wind farm.

### Description of the Related Art

Basic control of wind turbines on the basis of wake effects that are caused by other wind turbines arranged in the vicinity is known. To this end, it is conventionally specified for a specific wind direction whether there will be wake-induced effects on the turbines arranged downstream in the wind direction and, if so, the control of one or more wind turbines is adapted.

For example, it is thus known from WO 2004/111446 to curtail a wind turbine that is located in the vicinity of another wind turbine precisely when the other wind turbine is on the leeward side with respect to the wind turbine that is then curtailed. In this case, use is made of tabulated relationships, in particular from the wind direction and wake effect, which do not take into account the actual impairments to the other wind turbine.

The German Patent and Trademark Office has searched the following prior art in the priority application relating to the present application: DE 10 2010 016 292 A1, US 2017/0350369 A1, CN 206 592 245 U, US 2014/0003939 A1, EP 2 696 067 A2, US 2009/0099702 A1, DE 10 2016 212 364 A1, GB 2 481 461 A, GB 2 476 507 A, US 2013/0255363 A1, and WO 2008/041066 A1.

### BRIEF SUMMARY

Provided are techniques to specify an improved wake control system for a wind turbine, and also an improved wind farm and an improved method for controlling a wind turbine and a wind farm. The present invention relates in particular to a wind turbine having a wake control system that is configured so as to control the wind turbine on the basis of wake effects caused at a further wind turbine.

According to a first aspect, provided is a wind turbine having a wake control system that is configured so as to control the wind turbine on the basis of wake effects caused at a further wind turbine, in that the wake control system is configured so as to achieve control based on a turbulence measured value from a turbulence measurement sensor of the further wind turbine.

It is thus proposed not to use any pre-calculated or tabulated effects of wake effects that are stored in the wind turbine itself, but rather to use directly measured turbulence measured values for the control. An advantage arises from the fact that the turbulence measured value that is obtained at the further wind turbine is communicated between the wind turbines and influences the wake control system of the output turbine. The wake control system may accordingly be optimized such that the actual situation of the turbine possibly in the wake is taken into account.

In one preferred embodiment, the turbulence measured value is indicative of a turbulence and/or wind shear prevailing at a rotor of the further wind turbine.

In the context of this document, turbulence is understood to mean a temporal and/or spatial change in the incident wind flow on the rotor or in the rotor plane of the wind turbine. Turbulence accordingly includes for example the temporal variation in the wind speed, but also a vertical or horizontal variation in the wind speed, that is to say for example wind shear. The turbulence measured value should thus be understood to be any suitable measured value that is suitable for expressing this turbulence.

In one preferred embodiment, the further wind turbine is selected on the basis of an azimuth position and/or a determined wind direction.

The determined wind direction may be for example a wind direction measured at the wind turbine to be controlled or a wind direction provided for the entire wind farm, for example by a farm master. An advantage according to this embodiment is then that measured values from the same further wind turbine are not always used for wake control, but that it is possible, as it were, to select the most suitable source of the measured values to be used from the wind turbines that are preferably in the vicinity of one another. Measured values from a plurality of further wind turbines may preferably also be used, these being for example weighted and/or averaged in a suitable manner, for example on the basis of their distance from the wind turbine to be controlled.

In one preferred embodiment, the wake control system is configured so as to control at least one of an azimuth position, a pitch angle, a generator torque and a generator power.

By virtue of controlling the azimuth position, the rotor of the wind turbine may possibly be rotated with respect to the incident wind, for example in order to deflect the wake of the wind turbine and, if necessary, to reduce the turbulence for turbines in the wake. The purpose of controlling the pitch angle or the generator torque or else the generator power is to control the power of the wind turbine drawn from the wind; a lower drawn power is in particular suitable for reducing the turbulence at downstream turbines.

In one preferred embodiment, the wake control system is configured so as to achieve control based on a horizontal wind shear of the further wind turbine.

Horizontal wind shear is preferably defined as the difference in wind speed at two horizontally opposing points on the rotor plane. By way of example, the 3 o’clock position of the rotor and the 9 o’clock position of the rotor are suitable for this purpose, but positions located close to these positions or else average values over certain regions, for example from the 2 o’clock position to the 4 o’clock position with a corresponding equivalent on the opposite side, are likewise also conceivable. The regions may of course also be shifted in any direction, larger and/or smaller, taking into account the individual case.

If the horizontal wind shear is used as an indicator for the turbulence, this measure may be used to demonstrate particularly well that one wind turbine is entering the wake of another turbine. The turbulence of the turbine that is then in the wake will in particular first occur at one of the edge regions of the swept rotor plane and propagate from there over the further region of the rotor plane. One reason for this is that wind conditions do not change completely spontaneously, but rather the changes in wind conditions, for example the wind direction, occur over a specific, albeit possibly very short, period of time. Since the wind turbine detects that the turbine downstream in the wind measures a horizontal wind shear, that is to say if there is actually an influence on wake, the wake control system is able to control the wind turbine accordingly in order to reduce and/or to avoid the undesired effects at the further turbine.

Due to the fact that the sign of the wind shear indicates whether for example the wind is stronger in the 3 o’clock position or in the 9 o’clock position, using the horizontal wind shear in particular makes it possible to determine whether the leeward wind turbine is moving into the wake region of the wind turbine from the side of the 3 o’clock position or the 9 o’clock position. The wake control system may accordingly also preferably achieve control with respect to a sign of the horizontal wind shear.

In one preferred embodiment, the wake control system is configured so as to control the wind turbine when the turbulence measured value exceeds a determined first threshold value.

A measured turbulence may have various causes. In order to exclude natural causes, such as for example naturally occurring unsteady wind, as a control cause, the control according to this advantageous embodiment does not start until a certain turbulence measured value is exceeded.

In one preferred embodiment, the wake control system is configured so as to increase a pitch angle as soon as the turbulence measured value exceeds the determined first threshold value. With regard to this embodiment as well, exceeding the threshold value means that the wind turbine at which the turbulence measured value is measured is entering the wake of the upstream wind turbine. By increasing the pitch angle, the turbulence generated by the rotor is reduced and the turbulence resulting therefrom on the downstream turbine is accordingly reduced.

In one preferred embodiment, the wake control system is configured so as to record changes in the operating parameters and to reverse the last performed change as soon as the turbulence measured value exceeds the determined first threshold value.

The reasoning behind this embodiment is based on the fact that the last recorded change in the operating parameters led to the increase in the measured turbulence measured value at the turbine in the wake. By reversing this change, that is to say the cause of the measured turbulence, the undesired wake effects in the downstream wind turbine are reduced. This embodiment is of course not limited to exactly one recorded change; by way of example, the changes performed over a specific previous period of time, for example 10 minutes, or even a multiple of the previous recorded changes, may also be reversed.

In one preferred embodiment, the wake control system is configured so as to reverse a last recorded change in the azimuth position.

In particular, changing the azimuth position, that is to say tracking the nacelle of the wind turbine in the direction of the wind, may ensure that the turbulence generated by the wind turbine is directed in the direction of the further wind turbine and thus leads to undesired wake effects occurring there. By reversing the change in azimuth position that led to the entry of the downstream wind turbine into the wake, the nacelle of the wind turbine will be at an angle to the wind direction, which leads to a deflection of the turbulence that is generated. According to this deflection, the downstream turbine is then no longer in the wake region of the wind turbine whose azimuth position is rotated.

In one preferred embodiment of the above two preferred embodiments, the wake control system is configured so as to continue the reversal of the changes for as long as the turbulence measured value exceeds a determined second threshold value.

The reversal of the changes relates here in particular to the direction of the change, for example an increase or decrease in the pitch angle and/or an azimuth rotation to the left or right. If for example rotation of the nacelle to the left is found to be the cause of the entry of the downstream wind turbine into the wake of the wind turbine whose azimuth position is changed to the left, a rotation to the right takes place until the turbulence measured value is below the second threshold value. The second threshold value is preferably below the first threshold value that actually triggers the reversal of the previous change. In other examples, other values of the second threshold value, for example equal to the first threshold value, are of course also possible.

In one preferred embodiment, the wake control system is configured so as to change the azimuth position counter to the direction of the last recorded change until the turbulence measured value falls below the determined second threshold value. Below the second threshold value, it may accordingly be assumed that the wind turbine in question, at which the measured value is recorded, is no longer in the wake of the wind turbine that is being controlled.

In one preferred embodiment, the wake control system is configured so as to achieve control on the basis of the wind speed measured at the wind turbine. In particular, the factor of the change, for example the adaptation of the azimuth angle and/or the pitch angle, may then advantageously depend on the speed of the wind and thus on the overall wake effects to be expected. By way of example, high wind speeds will cause greater turbulence in the turbine arranged on the leeward side, such that greater corrections are required by the wake control system.

According to a second aspect, provided is a wind turbine. The wind turbine comprises a turbulence measurement sensor that is configured so as to determine a turbulence measured value, wherein the turbulence measured value is indicative of a turbulence and/or wind shear at the wind turbine. The wind turbine is configured so as to provide the turbulence measured value in order to control the wind turbine and/or a further wind turbine.

The turbulence measured values measured by the turbulence measurement sensor are also provided and used in particular to control a further wind turbine, that is to say in particular a turbine in the vicinity of the wind turbine and possibly causing wake effects. This makes it possible to use the measured turbulence measured values that actually occur in order to counteract the negative effects of the turbine being in the wake of the further wind turbine.

The wind turbine according to the second aspect may at the same time also be designed as a wind turbine according to the first aspect or a configuration described as preferred in this regard. In this respect, this wind turbine may then use the wake control system both to counteract the wake effects at further wind turbines and to ensure itself that further wind turbines are provided with the required turbulence measured values in order to carry out correspondingly effective wake control.

In one preferred embodiment, the turbulence measurement sensor is configured so as to provide a horizontal wind shear over the rotor as turbulence measured value.

In one preferred embodiment, the horizontal wind shear is measured as the difference in the wind speed on at least one rotor blade between two horizontally different blade positions.

In one preferred embodiment, the horizontal wind shear is determined as the difference in the wind speed at the 3 o’clock and 9 o’clock position. Of course, as explained above, other possibilities for determining and quantifying the horizontal wind shear are also possible.

In one preferred embodiment, the turbulence measurement sensor is configured so as to determine the turbulence measured value from loads acting on at least one rotor blade at different rotor positions. Other measurement principles that are based for example on a measured strain/bending of the rotor blade instead of measured loads are also conceivable. Optical measurement principles are preferably used to determine strain/bending, wherein other measurement principles may of course also be used.

In one preferred embodiment, the turbulence measurement sensor has a bending sensor. The turbulence measurement sensor is preferably configured so as to provide blade-root bending moments and/or torsion moments with a resolution of for example greater than 10 Hz, in particular approximately 40 Hz. Of course, other forms of turbulence measurement sensors are also possible.

In one preferred embodiment, the bending sensor is configured so as to determine the bending of a rotor blade in at least one position, in particular in a plurality of positions over the rotor blade. From the bending, it is possible to derive parameters that are indicative of the turbulence.

In one preferred embodiment, the turbulence measurement sensor is configured so as to measure a wind field over the rotor plane and to derive the turbulence from the measured wind field, in particular to derive it from a horizontal difference in the wind field. In one example, the difference may be derived from two extremes on either side of the wind field over the rotor plane. In other examples, average values over a larger region may also be used. By way of example, the extremes and/or the area average values may be values averaged over a specific period of time in order to further reduce the uncertainties due to measurement errors.

Also provided is a wind farm. The wind farm comprises at least one wind turbine according to the first aspect or an embodiment of the wind turbine according to the first aspect that is described as preferred. The wind farm furthermore comprises at least one wind turbine according to the second aspect or an embodiment of the wind turbine according to the second aspect that is described as preferred. The wind farm particularly preferably has one or more wind turbines that are designed according to the first and second aspect, that is to say are suitable both for providing the turbulence measured values and for achieving control based on other turbulence measured values. One, several or all of the turbines of the wind farm are preferably designed as wind turbines according to the first aspect and the second aspect and/or according to an embodiment of one or both of these aspects that is de-scribed as preferred.

Further provided is a method for controlling a wind turbine. A wake control system controls the wind turbine on the basis of wake effects caused at a further wind turbine. The wake control system controls the wind turbine based on a turbulence measured value from a turbulence measurement sensor of the further wind turbine.

The wind turbines that are possibly in the wake are preferably determined and/or already determined when the farm layout is defined. The turbines belonging to a specific wind direction are then selected from these wind turbines in question. The possibly suitable wind turbines may however also be determined only during operation, for example using a correlation of turbulence measured values, turbine parameters and/or wind direction of the wind farm. No limits on further designs in this respect are set by those skilled in the art.

Further provided is a method for controlling a wind farm having at least two wind turbines, wherein a wake control system controls a wind turbine on the basis of wake effects caused at a further wind turbine. The wake control system controls the wind turbine based on a turbulence measured value from a turbulence measurement sensor of the further wind turbine.

Further provided is the use of a turbulence measured value, which is indicative of a turbulence intensity on a rotor of a wind turbine, for controlling a further wind turbine of a wind farm.

### BRIEF DESCRIPTION OF THE SEVERAL VIEWS OF THE DRAWINGS

Further advantages and preferred configurations are described in more detail below with reference to the exemplary embodiments of the accompanying figures, in which:

FIG. 1 shows a wind turbine, schematically and by way of example,

FIG. 2 shows a wind farm, schematically and by way of example,

FIG. 3 shows profiles of a horizontal wind shear as an example of a turbulence measured value, schematically and by way of example, and

FIG. 4 shows profiles of a vertical wind shear as an example of a turbulence measured value, schematically and by way of example.

### DETAILED DESCRIPTION

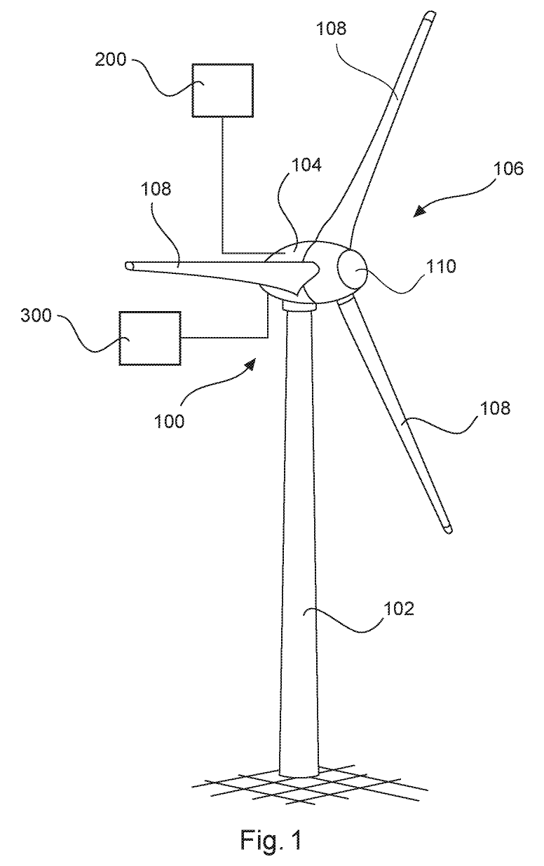

FIG. 1 shows a schematic illustration of a wind turbine according to the invention. The wind turbine 100 has a tower 102 and a nacelle 104 on the tower 102. An aerodynamic rotor 106 having three rotor blades 108 and having a spinner 110 is provided on the nacelle 104. During the operation of the wind turbine, the aerodynamic rotor 106 is set in rotational motion by the wind and thereby also rotates an electrodynamic rotor or runner of a generator, which is coupled directly or indirectly to the aerodynamic rotor 106. The electric generator is arranged in the nacelle 104 and generates electrical energy. The pitch angles of the rotor blades 108 may be changed by pitch motors at the rotor blade roots of the respective rotor blades 108.

In this exemplary embodiment, the wind turbine 100 is controlled by a wake control system 200, which is part of a controller of the wind turbine 100. The wake control sys-tem 200 is configured so as to use a turbulence measured value, which is preferably measured at another wind turbine 100, to change operating parameters of the wind turbine 100, in particular an azimuth position of the nacelle 104, a pitch angle of the rotor blades 108 and/or for example a generator torque, such that the turbulence generated by the wake of the wind turbine 100 is reduced as far as possible at the other turbine.

The wake control system 200 will generally be implemented as part of the control system of the wind turbine 100, which for example also comprises further control systems such as wind tracking, or a control system for complying with maximum loads/noise generation, etc., as is undoubtedly known to those skilled in the art in this field. The wake control system 200 may therefore be integrated into known control systems of wind turbines 100 without any problems.

The wind turbine 100 furthermore has a turbulence measurement sensor 300 that is con-figured so as to provide a measured value that describes a variation in the wind situation at the wind turbine 100. By way of example, the measured value may comprise a turbulence intensity, but also a horizontal and/or vertical wind shear. In general, all measured values that indicate that the wind turbine 100 is in the wake of a further wind turbine 100 are conceivable. Examples of such turbulence measurement sensors are LIDAR systems, wherein an optical measurement system that detects the bending of the rotor blades at different rotor blade positions over the rotor rotation are preferably used. From the optically detected bending, precise conclusions are then drawn about the wind conditions prevailing at very different positions on the rotor blade plane.

The wind turbine 100 of FIG. 1 is accordingly suitable both for responding to wake measurement signals from other wind turbines 100 through the wake control system 200 and furthermore for using the turbulence measurement sensor 300 to in turn provide the wake measurement signal to other wind turbines 100 in order to possibly advantageously adapt the operation through a wake control system that is present there. Other examples of wind turbines 100 may also comprise either the wake control system 200 or the turbulence measurement sensor 300.

Even though they are shown schematically outside the wind turbine 100 in the drawing, the wake control system 200 and the turbulence measurement sensor 300 will often be implemented at least partially within the wind turbine 100, for example within the nacelle 104.

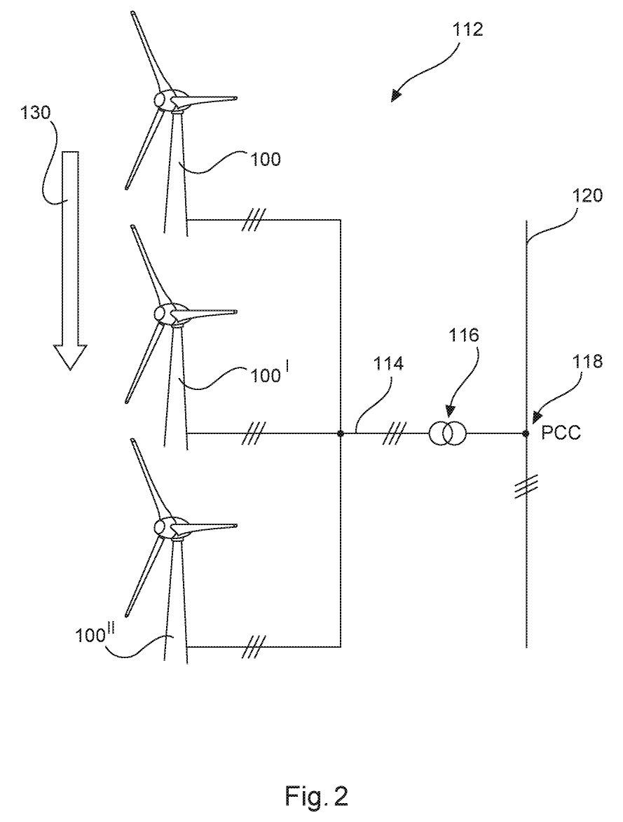

FIG. 2 shows a wind farm 112 having, by way of example, three wind turbines 100, 100ʹ, 100″ which may be identical or different. The three wind turbines 100, 100ʹ, 100″ are thus representative of basically any desired number of wind turbines of a wind farm 112. The wind turbines 100, 100ʹ, 100″ provide their power, specifically in particular the generated current, via an electrical farm grid 114. In this case, the respectively generated currents or powers of the individual wind turbines 100, 100ʹ, 100″ are added and a trans-former 116 is usually provided, which steps up the voltage in the farm in order to then feed into the supply grid 120 at the infeed point 118, which is also generally referred to as PCC. FIG. 2 is only a simplified illustration of a wind farm 112, which does not show for example a controller, although a controller is of course present. By way of example, the farm grid 114 may also be designed in another way by virtue of for example a trans-former also being present at the output of each wind turbine 100, 100ʹ, 100″, to mention just one other exemplary embodiment.

For the present application, there should in particular be provision for the farm grid 114 to furthermore be configured so as to transmit turbulence measurement signals from one wind turbine 100, 100ʹ, 100″ to other wind turbines 100, 100ʹ, 100″. A turbulence measured value measured by a turbulence measurement sensor at a wind turbine 100, 100ʹ, 100″ is then used to control a further one of the wind turbines 100, 100ʹ, 100″.

In the example of FIG. 2, for the sake of simplicity, it is assumed that the arrangement of the wind turbines 100, 100ʹ and 100″ shown vertically in the drawing corresponds to exactly one direction of the wind 130. The wind turbine 100ʹ is accordingly exactly in the wake of the wind turbine 100 and the wind turbine 100″ is exactly in the wake of the wind turbine 100ʹ. In the prevailing wind direction in this example, the wind turbine 100ʹ will accordingly provide turbulence measurement signals to the wind turbine 100, such that a wake control system 200 provided in the wind turbine 100 is able to respond thereto; the same will apply to the wind turbines 100″ and 100ʹ.

The selection of the wind turbines that provide turbulence measurement signals, that is to say wake measurement signals, to one or more of the other wind turbines may be made based on a programmed selection that is made for example on the basis of the wind direction. As an alternative or in addition, correlations between the turbulence measurement signals and the wind turbines may for example be used to adapt the selection and relationships of those wind turbines that provide signals and those wind turbines that receive and evaluate the associated signals.

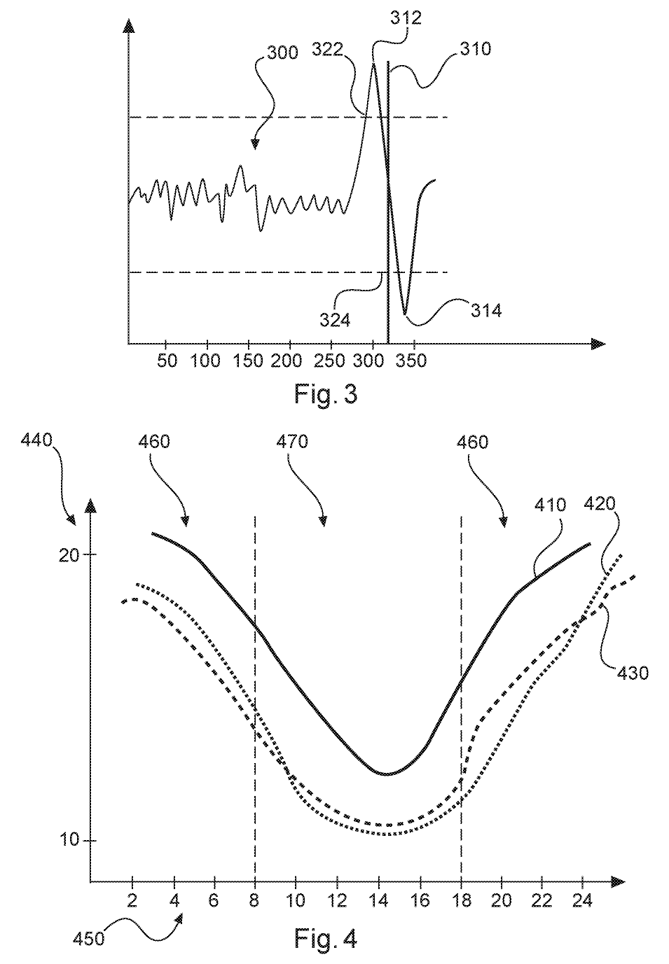

FIG. 3 shows profiles of a horizontal wind shear 300 as an example of a turbulence measured value, schematically and by way of example. The horizontal wind shear is plotted on the vertical axis, which is defined for example as the difference between the wind speed in a 3 o’clock position and a 9 o’clock position of the rotor. Other possibilities for determining the horizontal wind shear are also conceivable, as explained above.

In the example of FIG. 3, the azimuth position of the rotor is plotted on the horizontal axis, and may be roughly equated with the prevailing wind direction. In an azimuth position 310, the turbine at which the horizontal wind shear was measured is geometrically in the wake of another turbine. It may be seen that, to the left of the azimuth position 310, there is a significant increase with a maximum 312 of the horizontal wind shear. The rise on the left-hand side to the maximum 312 and the fall on the right-hand side of the azimuth position 310 toward the minimum 314 is precisely the influence of the wake corridor of the further turbine. In this example, the scale of the horizontal axis runs from 0 to 360, which corresponds to a full rotation of the nacelle 104 about the tower 102. The position of the upstream turbine at approximately 320 degrees, at which the center of the wake corridor is reached, should of course only be understood as an example.

When entering the wake corridor, the difference in wind speeds in the horizontal will initially increase, while if the wind turbine is in the center of the wake corridor, no note-worthy wake-induced horizontal wind shear should be expected. Only when the wake corridor is exited again on the other side is there again a clearly measurable horizontal wind shear with the opposing sign.

In order to determine whether the horizontal wind shear is of natural origin or induced by wake effects, it is advisable to define one or more threshold values 322, 324. The sign of the threshold values 322, 324 indicates the side of the rotor on which the wake effects may be noticed, since a reduced wind speed should be expected there. The threshold values 322, 324 may have the same value or different values in terms of their amount. The threshold values 322, 324 may also be specified as variable over time and in absolute or else relative terms with respect to the prevailing wind.

FIG. 4 shows profiles of a vertical wind shear 410, 420, 430 as a further example of a turbulence measured value, schematically and by way of example. The relative vertical wind shear is plotted on a vertical axis 440 by way of example as a percentage based on the average value of the wind speed measured over the rotor, while the course of a day from 0 to 24 hours is plotted on a horizontal axis 450 by way of example.

It may be seen that there are significantly higher relative vertical wind shears 410, 420 and 430 at night 460 than is the case during the day 470. The value of the vertical wind shear may be an indication of the extent to which the turbulence of the wake of a wind turbine is able to propagate at all, that is to say whether or not there are wake effects at the wind turbine on the leeward side.

The different profiles of the vertical wind shear 410, 420, 430 may be measured for example using different measurement methods, such as LIDAR or else using measuring masts.

Although vertical and horizontal wind shear have in particular been given as examples of suitable turbulence measured values, the invention is not limited thereto and further turbulence measured values that indicate temporal and/or spatial variations in the wind and are indicative of measurable wake effects are likewise also suitable.

1. A wind turbine comprising:
a wake control system configured to control the wind turbine based on wake effects caused at a further wind turbine,
wherein the wake control system is configured to control the wind turbine based on a turbulence measured value measured by a turbulence measurement sensor of the further wind turbine, and
wherein the wake control system is configured to control the wind turbine based on a sign of a horizontal wind shear of the further wind turbine.

2. The wind turbine according to claim 1,
wherein the turbulence measured value is indicative of a turbulence and/or wind shear prevailing at a rotor of the further wind turbine, and/or
wherein the further wind turbine is selected depending on an azimuth position and/or a determined wind direction, and/or
wherein the wake control system is configured to control at least one of an azimuth position, a pitch angle, a generator torque and a generator power of the further wind turbine.

3. The wind turbine according to claim 1,
wherein the wake control system is configured to control the wind turbine when the turbulence measured value exceeds a predetermined first threshold value, and
wherein the wake control system is configured to increase a pitch angle when the turbulence measured value exceeds the predetermined first threshold value.

4. The wind turbine according to claim 3,
wherein the wake control system is configured to log changes of operating parameters and to reverse a last performed change when the turbulence measured value exceeds the predetermined first threshold value, and
wherein the wake control system is configured to reverse a last logged change of the azimuth position.

5. The wind turbine according to claim 4, wherein the wake control system is configured to continue reversal of changes when the turbulence measured value exceeds a predetermined second threshold value.

6. The wind turbine according to claim 5, wherein the wake control system is configured to change the azimuth position counter to the direction of a last logged change until the turbulence measured value falls below the predetermined second threshold value.

7. The wind turbine according to claim 1, wherein the wake control system is configured to control the wind turbine based on wind speed measured at the wind turbine.

8. A wind farm comprising:
at least one wind turbine according to claim 1; and at least one wind turbine comprising a turbulence measurement sensor configured to measure a turbulence measured value,
wherein the turbulence measured value is indicative of a turbulence and/or wind shear at the wind turbine, and
wherein the wind turbine is configured to provide the turbulence measured value for controlling the wind turbine and/or a further wind turbine.

9. A method for controlling a wind turbine or a wind farm comprising a wind turbine, the method comprising:
controlling the wind turbine based on wake effects caused at a further wind turbine,
wherein the wake control system controls the wind turbine based on a turbulence measured value measured by a turbulence measurement sensor of the further wind turbine, and
wherein the wake control system is configured to control the wind turbine based on a sign of a horizontal wind shear of the further wind turbine.
